(19) United States
(12) Patent Application Publication
(10) Pub. No.: US 2008/0122559 A1
(43) Pub. Date: May 29, 2008

(54) Microwave Filter Including an End-Wall Coupled Coaxial Resonator

(76) Inventor: Michael Hoft, Asendorf (DE)

Correspondence Address: NIXON & VANDERHYE, PC, 901 NORTH GLEBE ROAD, 11TH FLOOR, ARLINGTON, VA, 22203, US

(21) Appl. No.: 11/919,985

(22) PCT Filed: Mar. 29, 2006
(86) PCT No.: PCT/EP2006/002870

§ 371 Date: Nov. 13, 2007

(30) Foreign Application Priority Data
May 30, 2005 (EP) 05011608.6

(51) Int. Cl. H01P 1/205

(52) U.S. Cl. 333/206

(57) ABSTRACT

The present invention relates to a microwave filter comprising a plurality of coupled resonators, wherein the plurality of coupled resonators includes at least one coaxial resonator comprising a housing having a lower end wall, a sidewall extending upwardly from the lower end wall and an upper end wall and an inner conductor disposed within the housing and extending upwardly from the lower end wall along the longitudinal axis of the housing. At least one of the coaxial resonators comprises in its lower end wall and/or in its upper end wall a coupling means for effecting electromagnetic coupling of the respective coaxial resonator with an adjacent resonator.

The present invention relates to a microwave filter comprising a plurality of coupled resonators including at least one coaxial resonator.

The microwave region of the electromagnetic spectrum finds widespread use in various fields of technology. Exemplary applications include wireless communication systems, such as mobile communication and satellite communication systems, as well as navigation and radar technology. The growing number of microwave applications increases the possibility of interference occurring within a system or between different systems. Therefore, the microwave region is divided into a plurality of distinct frequency bands. To ensure, that a particular device only communicates within the frequency band assigned to this device, microwave filters are utilized to perform band-pass and band reject functions during transmission and/or reception. Accordingly, the filters are used to separate the different frequency bands and to discriminate between wanted and unwanted signal frequencies so that the quality of the received and of the transmitted signals is largely governed by the characteristics of the filters. Commonly, the filters have to provide for a small bandwidth and a high filter quality.

For example, in communications networks based on cellular technology, such as the widely used GSM system, the coverage area is divided into a plurality of distinct cells. Each cell is assigned to a base station which comprises a transceiver that has to communicate simultaneously with a plurality of mobile devices located within its cell. This communication has to be handled with minimal interference. Therefore, the frequency range utilized for the communications signals associated with the cells are divided into a plurality of distinct frequency bands by the use of microwave filters. Due to the usually small size of the cells and the large number of mobile devices potentially located within a single cell at a time, the width of a particular band is chosen to be as small as possible. Moreover, the filters must have a high attenuation outside their pass-band and a low pass-band insertion loss in order to satisfy efficiency requirements and to preserve system sensitivity. Thus, such communication systems require an extremely high frequency selectivity in both the base stations and the mobile devices which often approaches the theoretical limit.

Commonly, microwave filters include a plurality of resonant sections which are electromagnetically coupled together in various configurations. Each resonant section constitutes a distinct resonator and usually comprises a space contained within a closed or substantially closed conducting surface. Upon suitable external excitation, an oscillating electromagnetic field may be maintained within this space. The resonant sections exhibit marked resonance effects and are characterized by the respective resonant frequency and band-width. In order for the filter to yield the desired filter characteristics, it is essential that the distinct resonators coupled together to form the filter have a predetermined resonant frequency and band-width or pass-band.

The coupling between adjacent resonant sections can e.g. be effected by providing an opening or coupling window in adjacent wall sections of the two resonant sections, which opening or coupling window interconnects the two spaces contained within the closed or substantially closed conducting surfaces of the two resonant sections. In this case, the coupling coefficient k, which represents the ratio of coupled energy to stored energy, depends on the relative orientation of the electric field vectors and on the relative orientation of the magnetic field vectors in the coupling plane defined by the coupling window. According to the textbook “Microstrip Filters for RF/Microwave Applications”, Jia-Sheng Hong and M. J. Lancaster, Wiley & Sons, 2001, page 244, the coupling coefficient may be calculated pursuant to the equation

$$k = \frac{\int \int \int ɛ {\vec{E}}_{1} \cdot {\vec{E}}_{2} d v}{\sqrt{\int \int \int ɛ {\vert {\vec{E}}_{1} \vert}^{2} d v \times \int \int \int ɛ {\vert {\vec{E}}_{2} \vert}^{2} d v}} + \frac{\int \int \int μ {\vec{H}}_{1} \cdot {\vec{H}}_{2} d v}{\sqrt{\int \int \int μ {\vert {\vec{H}}_{1} \vert}^{2} d v \times \int \int \int μ {\vert {\vec{H}}_{2} \vert}^{2} d v}} \qquad ( 1 )$$

where E and H are the electric and magnetic field vectors, v is the volume, ε is the permittivity, and μ is the permeability. As can be seen from this equation, the strongest electric or magnetic coupling is achieved if the electric or magnetic field lines, respectively, originating from the two resonators extend (anti-)parallel with respect to each, other in the region of overlap of the fields, whereas no coupling is achieved if the field lines extend perpendicular with respect to each other.

An example of one such type of microwave filter including a plurality of coupled resonant sections is described in “General TE₀₁₁-Mode Waveguide Bandpass Filters”, Ali E. Atia and Albert E. Williams; IEEE Transactions on Microwave Theory and Techniques, Vol. MTT-24, No. 10, October 1976, p. 640. This microwave filter consists of a plurality of coupled cylindrical waveguide cavities resonating in the TE₀₁₁-mode. The adjacent cavities are either coupled via axial magnetic fields through aligned axial slots in the cylindrical sidewalls or via radial magnetic fields through aligned radial slots in the end walls of the adjacent cavities. For the coupling utilizing radial slots in the end walls, positive coupling between two cavities can be achieved by aligning them so that their axes are coincident, and negative coupling can be achieved by arranging the cavities such that their axes are parallel but offset by one-half diameter with respect to each other. This filter has been designed for the particular field configuration of the TE₀₁₁-mode.

A further example of a microwave filter is given in “Full-Wave Design of Canonical Ridge Waveguide Filters”, Jorge A. Ruiz-Cruz et al., 2004 IEEE MTT-S Digest, p 603. This filter consists of two single ridge rectangular waveguide sections which share a common sidewall, wherein the ridges extend from the sidewalls opposite the common sidewall. In the common sidewall, a number of coupling windows are provided.

One particular type of resonator regularly used to build microwave filters is known as coaxial resonator. Essentially, this resonator structure can be regarded as a section of coaxial transmission line that is short-circuited at one end and capacitively loaded (open) at the other end. Accordingly, it comprises a housing defining a cavity and having a longitudinal axis, and a coaxial inner conductor electrically connected to the housing at only one end. In a certain distance above the open end of the inner conductor, the housing is closed by a cover so that a gap exists between one end of the inner conductor and the inner surface of the cover. The free space between the top of the inner conductor and the cover is referred to as the capacitive gap.

Coaxial resonators are distinctly different from the waveguide filters mentioned above. A further example of a waveguide filter is a dielectric resonator. For example, cavity resonators are waveguide resonators comprising a waveguide section—generally having a rectangular, circular or oval cross-section—closed at both sides. Due to the presence of only one conductor, waveguide resonators do not support the transversal electromagnetic (TEM) mode but only the transversal electric (TE) and transversal magnetic (TM) modes. Further, they have a distinct cut-off frequency above which electromagnetic energy will propagate and below which it is attenuated. The cut-off frequency is determined by the cross-sectional dimensions. For example, a waveguide having a rectangular cross-section must have a width at least greater than one-half of the free space wavelength for propagation to occur at a particular frequency. Waveguides can support an infinite number of modes, each having its own cut-off frequency.

By contrast, coaxial resonators belong to the category of TEM-transmission line resonators supporting the TEM-mode which has zero cut-off frequency. They exhibit an entirely different distribution of the electromagnetic field. A coaxial resonator has a height of lower than λ/4—typically λ/8—where λ is the wavelength corresponding to the center of the pass-band. The short (electrical connection between inner conductor and base plate) at the bottom of the resonator is transformed to an inductance at the top of the resonator, which together with the capacitive gap at the top of the resonator create the fundamental resonance. Since the TE- and TM-modes of the resonator exhibit a strong dependency on the resonator diameters, the outer diameter of the resonator should be kept small—typically much smaller than λ/2 of the fundamental pass-band frequency—if the TE- and TM-modes are to be kept at higher frequencies than the TEM-mode. The ratio of the outer diameter of the resonator to the outer diameter of the inner conductor should lie around 3.6 to guarantee a high quality factor of the resonator, since at this ratio the damping constant of the corresponding coaxial line is minimal.

In the state of the art of microwave filters including coupled coaxial resonators, the coaxial resonators have been electromagnetically coupled side by side by means of coupling means disposed in the sidewalls of adjacent coaxial resonators. For example, in the filter shown in DE 196 23 144, the main path couplings are realized by means of magnetic couplings with coupling windows and by means of electric couplings with an electric probe, wherein the coupling windows and the probe are all located in the sidewalls of adjacent coaxial resonators. Further, a magnetic cross coupling is also provided by a coupling window in the sidewalls of adjacent coaxial resonators.

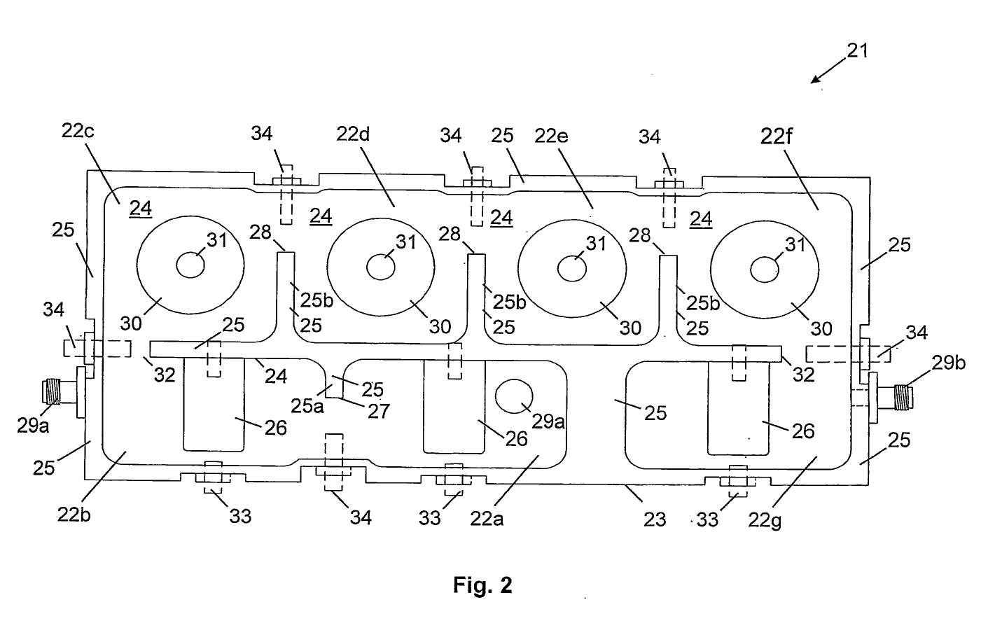

As a further example, a microwave filter shown in FIG. 8 of “High-Q TE₀₁ Mode DR Filters for PCS Wireless Base Stations”, Ji-Fuh Liang and William D. Blair, IEEE Transactions on Microwave Theory and Techniques, Vol. 46, No. 12, December 1998 includes coaxial resonators which are coupled with dielectric resonators resonating in the TE₀₁-mode. Thus, in this filter coupling between coaxial resonators and a different type of resonator is realized. This coupling is provided by placing the sidewall of a coaxial resonator against the sidewall of a dielectric resonator and by providing suitable coupling windows in the sidewalls. However, the coaxial resonator is arranged rotated by 90° with respect to the dielectric resonators to fit the orientation of the magnetic field. Thus, also in this case, coupling of the coaxial resonators is effected by means of a coupling means disposed in the sidewall of the coaxial resonator.

A general problem of filters including coaxial resonators is that the coupling of the coaxial resonators imposes restrictions on the flexibility of choosing an overall filter design suitable for a particular application. Accordingly, these filters are often accompanied by comparably high costs and/or a high space requirement. Moreover, when coupling a coaxial resonator with a different type of resonator such as a dielectric resonator, an arrangement with the coaxial resonator being rotated with respect to the dielectric resonator has the disadvantage of difficult manufacture. While this disadvantage can be avoided by utilizing a coupling loop or coupling probe which is bent to fit the different field arrangements of the different resonator types, such an arrangement requires more parts and increases the insertion loss.

It is an object of the present invention to provide a microwave filter comprising a plurality of resonators including at least one coaxial resonator which can be constructed in a cost-efficient and flexible way, and to facilitate coupling between coaxial resonators and other types of resonators.

This object is achieved by a microwave filter as defined in claim 1. Preferred embodiments of the microwave filter are set out in the dependent claims.

The microwave filter of the present invention comprises a plurality of electromagnetically coupled resonators. At least one of the plurality of coupled resonators is a coaxial resonator, which comprises a housing having a bottom wall or lower end wall, a sidewall extending upwardly from the lower end wall and an upper end wall as well as an inner conductor disposed within the housing and extending upwardly from the lower end wall along the longitudinal axis of the housing. According to the present invention, a coupling means is provided in the upper end wall and/or in the lower end wall of one, more or all of these coaxial resonators, and each of these end wall coupling means is utilized to couple its coaxial resonator with an adjacent resonator. Accordingly, the plurality of coupled resonators includes at least one coaxial resonator which comprises in its upper end wall and/or in its lower end wall a coupling means which is adapted to effect electromagnetic coupling with an adjacent resonator, i.e. electric coupling, magnetic coupling or a combination of electric coupling and magnetic coupling. Such coaxial resonators may only comprise an end wall coupling means in their upper end wall. However, it is preferred that one, more or all of such coaxial resonators comprise an end wall coupling means in their upper end wall as well as in their lower end wall, and it is even more preferred that one, more or all of such coaxial resonators only comprise an end wall coupling means in their lower end wall. The filter may solely comprise this type of coupling of coaxial resonators. However, it is preferred that the filter comprises coupling of coaxial resonators utilizing coupling means in the end walls in addition to sidewall coupling. Thus, it is preferred that some coaxial resonators are only coupled utilizing sidewall coupling and some coaxial resonators are coupled utilizing only end wall coupling or sidewall coupling in addition to end wall coupling.

The present invention is based on the unexpected finding that coaxial resonators do not necessarily have to be coupled utilizing the sidewall coupling found in the prior art, but that they likewise may advantageously be coupled using a coupling means in their lower end wall or their upper end wall. The invention provides the advantage that a microwave filter including coaxial resonators and having specific filter characteristics may be produced in a very flexible and cost-efficient way. A plurality of resonators, each closely meeting particular specifications, may be coupled without impairing the desired filter performance in a number of geometrical configurations. Thus, it is easy to create filters which require a low amount of space. Furthermore, a filter including a mixture of coaxial resonators and other resonator types may be constructed without the additional costs and production complexity associated with conventional filters of this type. Overall, a high degree of flexibility is provided.

In a preferred embodiment, at least one of the coupling means located in an end wall of one of the coaxial resonators, i.e. at least one of the end wall coupling means, is adapted to provide magnetic coupling with the adjacent resonator. Thus, for at least one of the coaxial resonators having a coupling means in its lower end wall and/or its upper end wall, at least one of the end wall coupling means is adapted to provide magnetic coupling with the adjacent resonator. This means that, in accordance with the normal understanding of the term “magnetic coupling” by the person skilled in the art, the coupling of electromagnetic energy provided by such a coupling means is predominantly effected via the magnetic field, i.e. magnetic coupling is the dominant coupling mode. While, a coupling means adapted to provide magnetic coupling may be constructed so as to provide pure magnetic coupling, in general there will also be some degree of electric coupling (see also equation 1). Such an end wall coupling means may advantageously comprise a coupling window, a coupling iris or a coupling loop. In the case of a coupling window, tuning the coupling strength may be allowed for by providing a screw which extends into the coupling window for an adjustable distance. Such a tuning screw has the biggest influence on the coupling strength if it is arranged to extend perpendicular to the magnetic field lines. A coupling means located in the lower end wall or in the upper end wall of coaxial resonators providing magnetic coupling may be adapted to provide magnetic coupling with a positive or a negative coupling sign. It is preferred that one, more or all of such coupling means located in an end wall of one of the coaxial resonators and adapted to provide magnetic coupling, i.e. at least one of the end wall coupling means adapted to provide magnetic coupling, is located in the lower end wall.

In a further preferred embodiment, at least one of the coupling means located in an end wall of one of the coaxial resonators, i.e. at least one of the end wall coupling means, is adapted to provide electric coupling with the adjacent resonator. Thus, for at least one of the coaxial resonators having a coupling means in its lower end wall and/or its upper end wall, at least one of the end wall coupling means is adapted to provide electric coupling with the adjacent resonator. This means that, in accordance with the normal understanding of the term “electric coupling” by the person skilled in the art, the coupling of electromagnetic energy provided by such a coupling means is predominantly effected via the electric field, i.e. electric coupling is the dominant coupling mode. While, a coupling means adapted to provide electric coupling may be constructed so as to provide pure electric coupling, in general there will also be some degree of magnetic coupling. Such an end wall coupling means may advantageously comprise an electric probe. It is preferred that one, more or all of such coupling means located in an end wall of one of the coaxial resonators and adapted to provide electric coupling, i.e. at least one of the end wall coupling means adapted to provide electric coupling, is located in the lower end wall.

In a further preferred embodiment, at least one of the coupling means located in an end wall of one of the coaxial resonators, i.e. at least one of the end wall coupling means, is adapted to provide magnetic as well as electric coupling with the adjacent resonator. Thus, for at least one of the coaxial resonators having a coupling means in its lower end wall and/or its upper end wall, at least one of the end wall coupling means is adapted to provide magnetic as well as electric coupling with the adjacent resonator. Such a coupling means provides coupling of electromagnetic energy, wherein neither electric nor magnetic coupling is dominant. It is preferred that one, more or all of such coupling means located in an end wall of one of the coaxial resonators and adapted to provide magnetic as well as electric coupling, i.e. at least one of the end wall coupling means adapted to provide magnetic as well as electric coupling, is located in the lower end wall.

In a further preferred embodiment, the plurality of coupled resonators includes at least one pair of adjacent coupled coaxial resonators, each comprising in its lower end wall and/or in its upper end wall a coupling means, which coaxial resonators are coupled utilizing coupling means located in an end wall of the two resonators, and which are arranged with their lower end walls or with their upper end walls adjacent and facing each other (this includes the case in which the resonators share a common upper or lower end wall or in which at least a portion of these end walls are formed by a common component) or with the lower end wall of one coaxial resonator adjacent and facing the upper end wall of the other coaxial resonator (this includes the case of the lower end wall of the first resonator forming at least a part of the upper end wall of the second resonator). Accordingly, for the first of the above two cases, the two coaxial resonators forming such a pair are provided with a coupling means in their lower end wall or their upper end wall, respectively, whereas for the second of the above two cases, one coaxial resonator is provided with a coupling means in its lower end wall and the other coaxial resonator is provided with a coupling means in its upper end wall. In any case, the coupling means are arranged to cooperate such that they form a common coupling means providing coupling of the two resonators. Where the adjacent end walls are formed at least in part by a common component, the two coupling means, such as a coupling window, may be formed by a single common coupling means, such as a common coupling window. In this way, new geometrical arrangements of microwave filters including a plurality of coupled coaxial resonators can be realized. It is preferred that at least one of such pairs of coaxial resonators coupled with one of their end walls adjacent each other (i.e. one, more or all of these pairs), includes a coaxial resonator which is disposed with its lower end wall adjacent an end wall of the other coaxial resonator, and preferably both coaxial resonators are disposed with their lower end walls adjacent each other.

In the case of a pair of end wall coupled adjacent coaxial resonators, it is further advantageous that the cooperating coupling means located in the adjacent end walls are formed by coupling windows providing for magnetic coupling, and that the longitudinal axes of the two coaxial resonators forming such a pair are offset with respect to each other. The invention has a particular advantage when two adjacent coaxial resonators have to be coupled with a negative coupling sign. In the prior art, negative coupling was only achievable by using an electric probe between the coaxial resonators. However, as compared to a coupling window (effecting magnetic coupling) use of an electric probe is always related with additional costs due to the necessity of more parts as well as an increase of the insertion loss due to ohmic losses. On the other hand, magnetic coupling with windows in the sidewalls only result in positive coupling. It has been found that this is due to the resonators being arranged in one plane so that the magnetic field lines are always rotating in the same direction around the inner conductors of the coaxial resonators. However, negative magnetic coupling between two adjacent coaxial resonators using coupling windows may be realized by one of the above-described pairs of end wall coupled adjacent coaxial resonators, wherein the cooperating coupling means located in the adjacent end walls are formed by coupling windows providing for magnetic coupling, and wherein the longitudinal axes of the two coaxial resonators forming such a pair are offset with respect to each other. In any case, the coupling windows are aligned with respect to each other such that they form a common coupling window. Due to the fact that the sign of the coupling is not only defined by magnetic or electric coupling, but also by the relative orientation of the fields inside the coaxial resonators, negative magnetic coupling may be achieved by suitably shifting the longitudinal axes of the two coaxial resonators with respect to each other. As can be seen from above equation (1), the strongest negative magnetic coupling is obtained by shifting the two resonators such that the magnetic field lines originating from the two resonators extend anti-parallel with respect to each other in the region of overlap of the magnetic fields. Such a negative magnetic coupling may advantageously be utilized to provide main coupling or cross coupling.

In a further preferred embodiment, the plurality of coupled resonators includes at least one pair of adjacent coupled coaxial resonators, one of the coaxial resonators forming such a pair being disposed with its lower end wall or its upper end wall adjacent the sidewall of the other coaxial resonator forming such a pair, wherein the two coaxial resonators comprise coupling means in the adjacent walls which coupling means are aligned with respect to each other and cooperate to provide the coupling between the two coaxial resonators. Accordingly, the plurality of coupled resonators includes at least one coaxial resonator which comprises in its lower end wall and/or in its upper end wall a coupling means, and which is disposed with one of its end walls, in which a coupling means is located, and preferably with its lower end wall adjacent the sidewall of an adjacent coaxial resonator. The latter coaxial resonator comprises a coupling means in the portion of its sidewall which is disposed adjacent the end wall of the other coaxial resonator. This includes the case in which the at least a part of the end wall of the first resonator is formed by a portion of the sidewall of the other resonator. The coupling means in the adjacent wall sections are arranged to cooperate such that they form a common coupling means providing coupling of the two resonators. In this way, new geometrical arrangements of microwave filters including a plurality of coupled coaxial resonators can be realized.

The invention provides a further particular advantage if the plurality of resonators includes at least one TE-mode resonator and/or at least one TM-mode resonator, i.e. a mixture of different resonator types. In this case, it is preferred if at least one of the coaxial resonators comprising in its lower end wall and/or in its upper end wall a coupling means is coupled with a TE-mode resonator or a TM-mode resonator by means of a coupling means provided in the upper end wall or preferably in the lower end wall of the coaxial resonator. Such an arrangement may be easier manufactured as compared to the side-by-side arrangement of the prior art in which the resonators are rotated by 90° with respect to each other and in any case provides an additional degree of flexibility for the filter design. The coupling may advantageously be effected by arranging a coaxial resonator having a coupling means in its upper end wall or preferably a coaxial resonator having a coupling means located in its lower end wall such that, the upper end wall or the lower end wall, respectively, faces the sidewall of the TE-mode resonator or TM-mode resonator (this includes the case of the end wall and the adjacent sidewall being formed at least in part by a common element), as the case may be, and by providing a coupling means in the sidewall of the TE-mode resonator or TM-mode resonator, as the case may be, which cooperates with the coupling means in the adjacent end wall of the coaxial resonator. The TE-mode resonators and/or TM-mode resonators may include at least one dielectric resonator and/or at least one cavity resonator.

In a preferred embodiment, the resonators are coupled in a two- or a three-dimensional array. In this way, complex filters having a suitable geometrical configuration can be made to provide specific filter characteristics.

Further, it is preferred if the resonators are coupled such that there is cross coupling between at least two of the resonators. This possibility is highly advantageous as cross coupling can improve the filter performance in various ways and many filter characteristics can only be obtained utilizing cross coupling. It is further preferred if the resonators are coupled such that there is cross coupling between at least one of the coaxial resonators having a coupling means in its lower end wall and/or in its upper end wall and an adjacent resonator, wherein the cross coupling is provided using a coupling means in the upper end wall or preferably in the lower end wall of the coaxial resonator. In this case, it may be advantageous if at least one of the coupling means in the upper end wall or in the lower end wall of one of the coaxial resonators, i.e. at least one of the end wall coupling means, providing cross coupling is adapted to provide negative cross coupling. In particular, it may be advantageous if at least one of the coupling means in the lower end wall or the upper end wall of one of the coaxial resonators providing cross coupling is adapted to provide magnetic cross coupling with a negative cross coupling sign.

In a preferred embodiment, the plurality of coupled resonators only includes coaxial resonators. Such filters may include sections constituting conventional combline or interdigital filters.

While, it is possible that the plurality of coupled resonators also includes at least one coaxial resonator having a coupling means in its upper end wall by which this coaxial resonator is coupled with an adjacent resonator, it is preferred if the plurality of coupled resonators includes at least one coaxial resonator comprising a coupling means in its lower end wall. It is particularly preferred if at least one of these coaxial resonators comprising a coupling means in its lower end wall does not include a coupling means in its upper end wall. It can be advantageous, if the plurality of coupled resonators includes no coaxial resonator comprising a coupling means in its upper end wall. Coupling means in the lower end wall are preferred because they provide for stronger coupling (due to the higher strength of the magnetic field at the bottom) and because at the top electric fields have to be taken into consideration.

In a further preferred embodiment, one, more or all of the coaxial resonators having a coupling means in their lower end wall and/or in their upper end wall have a cylindrical housing and/or a cylindrical inner conductor.

In the following, the invention is explained in more detail for preferred embodiments with reference to the figures.

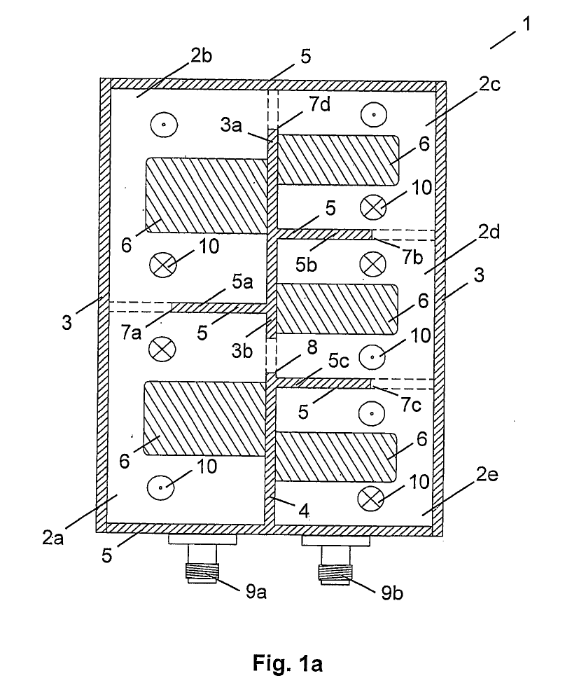

FIG. 1a is a schematic perspective top view of a microwave filter comprising a plurality of coupled coaxial resonators.

FIG. 1b is a schematic perspective side view of the left side of the filter shown in FIG. 1a.

FIG. 1c is a schematic perspective side view of the right side of the filter shown in FIG. 1a.

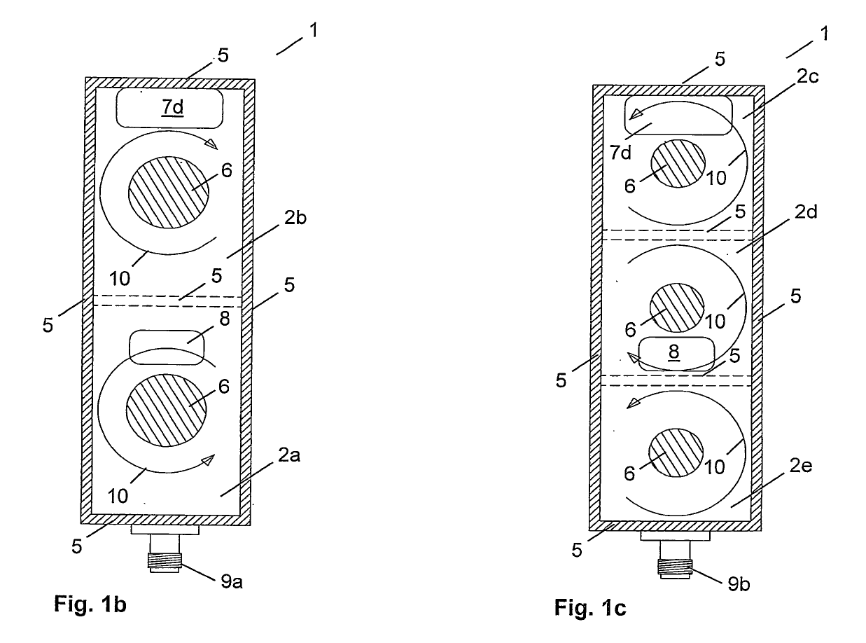

FIG. 2 is a schematic perspective view of a microwave filter comprising a plurality of coupled resonators including coaxial resonators and TE-mode resonators.

In FIGS. 1a to 1c, a microwave filter 1 is shown. The filter 1 comprises five distinct coaxial resonators 2a, 2b, 2c, 2d and 2e which have a rectangular cross-section and which are coupled in a two-dimensional array. Each of the coaxial resonators 2a to 2e comprises a hollow housing, which is constituted by a top wall or upper end wall 3 (the upper end walls of the resonators 2a and 2b are formed by a single plate-shaped section, and the upper end walls of the resonators 2c to 2e are likewise formed by a single plate-shaped section), a bottom wall or lower end wall 4 (the lower end walls of all resonators are formed by a single plate-shaped element), and a sidewall 5 (some of which are formed by the same plate-shaped elements) extending upwardly from the respective lower end walls 4. As can be appreciated from FIGS. 1b and 1c, the sidewalls 5 have a rectangular configuration comprising four interconnected wall sections arranged at the four sides of the respective rectangular lower end wall 4 to laterally encircle the lower end wall. The five resonators 2a to 2e are arranged in a unitary structure in which a part of the sidewalls 5 of the adjacent resonators 2a and 2b is formed by a common element 5a. The same is true for the adjacent resonators 2c and 2d as well as for the adjacent resonators 2d and 2e which comprise sidewalls 5 sharing in part common elements 5b and 5c, respectively. Furthermore, the lower end wall 4 of resonator 2a forms the lower end wall 4 of resonator 2e and a part of the lower end wall 4 of resonator 2d, and the lower end wall 4 of resonator 2b forms the lower end wall 4 of resonator 2c and a part of the lower end wall 4 of resonator 2d.

For reasons of weight and costs, the housings of the resonators 2a to 2e are preferably composed of aluminum. However, they may also advantageously be composed of iron, copper, brass or Invar, or may be a composite component comprising two or more of these or other materials. Further advantageous choices of materials include polymer or ceramic materials. It is only important that the resonators 2a to 2e can be produced according to the desired characteristics and that the material is a good conductor or is plated with a good conducting material such as silver.

Each resonator 2a to 2e further comprises a cylindrical inner conductor 6, centrally attached at its lower end to the respective lower end wall 4 of the housing. The inner conductors 6 extend upwardly from the lower end walls 4 along the longitudinal axis of the respective housing. The length of the inner conductors 6 is lower than the length of the housings so that a capacitive gap is formed between the upper end of the inner conductors 6 and the respective upper end wall 3. The inner conductors 6 are preferably composed of the same material as the housing to which they are connected so that the resonators 2a to 2e can advantageously be integrally produced in one piece with at least a part of the housing such as the lower end wall 4, e.g. by milling from a block of suitable material or by molding. However, the inner conductors 6 can also be provided as separate elements. In this case, they are preferably composed of aluminum, iron, copper, brass, Invar, a polymer material or a ceramic material, or they may be composite components comprising two or more of these materials. Again, it is only important that resonators 2a to 2e can be produced according to the desired characteristics and that the material is a good conductor or is plated with a good conducting material such as silver. In case the inner conductors 6 are not formed integrally with at least a part of the housing, the inner conductors 6 may be attached to the lower end wall 4 by means of screws or bolts, by soldering or brazing, by using a suitable adhesive, or by means of mating threads provided on the lower end wall 4 and on the inner conductors 6.

The coaxial resonators 2a and 2b are coupled by a coupling window 7a provided in the common section 5a of the sidewalls 5 separating the resonators 2a and 2b. Similarly, the coaxial resonators 2c and 2d are coupled by a coupling window 7b provided in the common section 5b of the sidewalls 5 separating the resonators 2c and 2d, and the coaxial resonators 2d and 2e are coupled by a coupling window 7c provided in the common section 5c of the sidewalls 5 separating the resonators 2d and 2e. Accordingly, these resonators are coupled by the well-known sidewall coupling. By contrast, coupling between the adjacent coaxial resonators 2b and 2c is effected by a coupling window 7d provided in the common section 3a of the lower end walls 4 separating the resonators 2b and 2c, i.e. by a coupling means provided in the lower end walls of these resonators. The sequence of the resonators 2a, 2b, 2c, 2d and 2e constitutes the main path of the microwave filter 1.

A further coupling window 8 is provided between the adjacent resonators 2a and 2d, which are not adjacent along the main path, to provide cross coupling. The coupling window 8 is provided in the common section 3b of the lower end walls 4 separating the resonators 2a and 2d. Thus, like the coupling window 7d, the coupling window 8 is a coupling means provided in the lower end walls of the two coupled resonators.

The field in the filter 1 is excited and extracted by means of suitable coupling means 9a and 9b, respectively, which may e.g. comprise an aperture or a coupling loop. The distribution of the magnetic field in the resonators 2a to 2e is indicated by characteristic field lines 10. While the longitudinal axes of the two resonators 2b and 2c are offset with respect to each other, the coupling window 7d is arranged to be located on the same side of the inner conductors 6 of these resonators. Therefore, the coupling window 7d provides magnetic coupling with a positive coupling sign. By contrast, the coupling window 8 is arranged to be located on opposite sides of the inner conductors 6 of the coaxial resonators 2a and 2d, the longitudinal axes of which are also offset with respect to each other. This arrangement of the coupling window 8 has been chosen to achieve magnetic cross coupling having a negative coupling sign by means of the opposite orientation of the magnetic field vectors in the two resonators on both sides of the coupling window 8.

The microwave filter 1 has a very compact and space-saving configuration, advantageously providing negative cross coupling utilizing a coupling window.

In FIG. 2, a further embodiment of a microwave filter according to the invention is shown. The filter 21 comprises three coaxial resonators 22a, 22b and 22g as well as four dielectric resonators 22c, 22d, 22e and 22f (resonating in a TE-mode), wherein the seven resonators 22a to 22g are coupled together in a two-dimensional array. The coaxial resonators 22a, 22b and 22g are identical to the coaxial resonators 2a to 2e of the first embodiment. Accordingly, they comprise a housing having a top wall or upper end wall 23, a bottom wall or lower end wall 24 and a sidewall 25 as well as an inner conductor 26. Again, the upper end walls 23, the lower end walls 24 and some of the sidewalls 25 of the coaxial resonators are formed by a single plate-shaped element. The dielectric resonators 22c to 22f each comprise a housing having a top wall or upper end wall (not shown), a bottom wall or lower end wall 24 and a sidewall 25. Further, the dielectric resonators 22c to 22f each comprise a dielectric puck 30 disposed on a suitable support 31.

It will be appreciated from FIG. 2, that the sidewalls 25 of the dielectric resonators 22c to 22f facing the coaxial resonators 22a, 22b and 22g are formed by a single plate-shaped element which also forms the lower end walls 24 of the coaxial resonators 22a, 22b and 22g. Accordingly, each coaxial resonators 22a, 22b and 22g is arranged with its lower end wall 24 against one sidewall 25 of at least one of the dielectric resonators 22c to 22f.

Each of the coaxial resonators 22a, 22b and 22g comprises a tuning screw 33 extending through a hole provided in the upper end wall 23 above the respective inner conductor 26. The tuning screws 33 can be moved into or out of the coaxial resonator 22a, 22b and 22g in order to change the capacitive gap between the top of the inner conductor 26 and the upper end wall 23, and to thereby adjust the resonant frequency.

The coaxial resonators 22a and 22b are coupled by a coupling window 27 provided in a common section 25a of the sidewalls 25 separating the resonators 22a and 22b. Similarly, the dielectric resonators 22c and 22d, the dielectric resonators 22d and 22e, and the dielectric resonators 22e and 22f are coupled by coupling windows 28 provided in the common section 25b of the sidewalls 25 separating these pairs of resonators. Coupling between the coaxial resonator 22b and the dielectric resonator 22c, i.e. between resonators of a different type, is effected by a coupling window 32 provided in the lower end wall 24 of the coaxial resonator 22b which also constitutes the sidewall of the dielectric resonator 22c. The coupling window 32 is a coupling means provided in the lower end wall of coaxial resonator 22b (and at the same time a coupling means provided in the sidewall 25 of dielectric resonator 22c). Similarly, coupling between the coaxial resonator 22g and the dielectric resonator 22f is effected by a coupling window 32 provided in the lower end wall 24 of the coaxial resonator 22g which also constitutes the sidewall 25 of the dielectric resonator 22f. The field in the filter 21 is excited and extracted by means of suitable coupling means 29a and 29b, respectively, which may e.g. comprise an aperture or a coupling loop. In this embodiment, there is only one possible path for the electromagnetic field from the input coupling means 29a to the output coupling means 29b, i.e. there is no cross coupling.

For each of the coupling windows 27, 28, 32, a tuning screw 34 is provided which is arranged to extend into the respective window. By moving the tuning screws 34 into or out of the window, the coupling strength can be adjusted.

While there is no cross coupling in filter 21, it would easily be possible to introduce cross coupling by providing a suitable coupling means between a coaxial resonator, such as coaxial resonator 22a, and a dielectric resonator, such as dielectric resonator 22d. Such a coupling means would be arranged in the lower end wall of the respective coaxial resonator and in the sidewall of the respective dielectric resonator. Similar to the case of coupling window 8 of the filter 1 shown in FIG. 1, such a coupling window could be adapted to provide for negative magnetic cross coupling. For example, magnetic cross coupling having a negative coupling sign could be achieved by providing a coupling window located in the lower end wall 24 of coaxial resonator 22a and in the sidewall 25 of dielectric resonator 22d. This is due to the opposite orientation of the magnetic field vectors in the two resonators on both sides of such a coupling window.

The microwave filter 21 has a very compact and space-saving configuration, advantageously providing coupling between a coaxial resonator and a dielectric resonator utilizing a coupling window.

1. A microwave filter comprising a plurality of coupled resonators, wherein the plurality of coupled resonators includes at least one coaxial resonator comprising:
a housing having a lower end wall, a sidewall extending upwardly from the lower end wall and an upper end wall; and
an inner conductor disposed within the housing and extending upwardly from the lower end wall along the longitudinal axis of the housing,
wherein at least one of the coaxial resonators comprises in its lower end wall and/or in its upper end wall a coupling means for effecting electromagnetic coupling of the respective coaxial resonator with an adjacent resonator.

2. The microwave filter according to claim 1, wherein at least one of the coaxial resonators comprises in its lower end wall and/or in its upper end wall a coupling means which is adapted to provide magnetic coupling with an adjacent resonator.

3. The microwave filter according to claim 2, wherein in at least one of the coaxial resonators comprising in its lower end wall and/or in its upper end wall a coupling means adapted to provide magnetic coupling with an adjacent resonator, at least one of the coupling means located in the lower end wall and/or in the upper end wall and adapted to provide magnetic coupling with an adjacent resonator is a coupling window.

4. The microwave filter according to claim 3, wherein for at least one of the coupling windows a screw is provided intruding into the coupling window along an adjustable distance to tune the coupling strength.

5. The microwave filter according to claim 2, wherein in at least one of the coaxial resonators comprising in its lower end wall and/or in its upper end wall a coupling means adapted to provide magnetic coupling with an adjacent resonator, at least one of the coupling means located in the lower end wall and/or in the upper end wall and adapted to provide magnetic coupling with an adjacent resonator is a coupling loop.

6. The microwave filter according to claim 2, wherein in at least one of the coaxial resonators comprising in its lower end wall and/or in its upper end wall a coupling means adapted to provide magnetic coupling with an adjacent resonator, at least one of the coupling means located in the lower end wall and/or in the upper end wall and adapted to provide magnetic coupling with an adjacent resonator is adapted to provide positive coupling.

7. The microwave filter according to claim 2, wherein in at least one of the coaxial resonators comprising in its lower end wall and/or in its upper end wall coupling means adapted to provide magnetic coupling with an adjacent resonator, at least one of the coupling means located in the lower end wall and/or in the upper end wall and adapted to provide magnetic coupling with an adjacent resonator is adapted to provide negative coupling.

8. The microwave filter according to claim 1, wherein at least one of the coaxial resonators comprises in its lower end wall and/or in its upper end wall a coupling means which is adapted to provide electric coupling with an adjacent resonator.

9. The microwave filter according to claim 8, wherein in at least one of the coaxial resonators comprising in its lower end wall and/or in its upper end wall a coupling means adapted to provide electric coupling with an adjacent resonator, at least one of the coupling means located in the lower end wall and/or in the upper end wall and adapted to provide electric coupling with an adjacent resonator is an electric probe.

10. The microwave filter according to claim 1, wherein at least one of the coaxial resonators comprises in its lower end wall and/or in its upper end wall coupling means which is adapted to provide magnetic as well as electric coupling with an adjacent resonator.

11. The microwave filter according to claim 1, wherein the plurality of coupled resonators includes at least one pair of adjacent coupled coaxial resonators, each comprising in its lower end wall and/or in its upper end wall a coupling means, one of the coaxial resonators forming such a pair being disposed with its lower end wall or its upper end wall adjacent the lower end wall of the upper end wall of the other coaxial resonator forming such a pair, wherein the two coaxial resonators comprise coupling means in the adjacent end walls which coupling means are aligned with respect to each other and cooperate to provide the coupling between the two coaxial resonators.

12. The microwave filter according to claim 11, wherein in at least one of these pairs of coaxial resonators coupled with one of their end walls adjacent each other, one of the two coaxial resonators is disposed with its lower end wall adjacent an end wall of the other coaxial resonator.

13. The microwave filter according to claim 11, wherein in at least one of these pairs of coaxial resonators coupled with one of their end walls adjacent each other, the two coaxial resonators are disposed with their lower end walls adjacent each other.

14. The microwave filter according to claim 11, wherein for at least one of these pairs of coaxial resonators coupled with one of their end walls adjacent each other, the cooperating coupling means located in the adjacent end walls are formed by coupling windows providing for magnetic coupling, and wherein the longitudinal axes of the two coaxial resonators forming such a pair are offset with respect to each other.

15. The microwave filter according to claim 14, wherein for at least one of these pairs of coaxial resonators coupled with one of their end walls adjacent each other and arranged with their longitudinal axes offset with respect to each other, the offset is chosen such that the magnetic coupling provided by the coupling windows has a negative coupling sign.

16. The microwave filter according to claim 15, wherein for at least one of these pairs of coaxial resonators coupled with one of their end walls adjacent each other and arranged with their longitudinal axes offset with respect to each other such that the magnetic coupling provided by the coupling windows has a negative coupling sign, the magnetic coupling having a negative coupling sign provides cross coupling.

17. The microwave filter according to claim 1, wherein the plurality of coupled resonators includes at least one pair of adjacent coupled coaxial resonators, one of the coaxial resonators forming such a pair being disposed with its lower end wall or its upper end wall adjacent the sidewall of the other coaxial resonator forming such a pair, wherein the coaxial resonators comprise coupling means in the adjacent walls which coupling means are aligned with respect to each other and cooperate to provide the coupling between the two coaxial resonators.

18. The microwave filter according to claim 17, wherein in at least one of these pairs of coaxial resonators coupled with one of the end walls of one coaxial resonator adjacent the sidewall of the other coaxial resonator, one of the two coaxial resonators is disposed with its lower end wall adjacent the sidewall of the other coaxial resonator.

19. The microwave filter according to claim 1, wherein the plurality of resonators includes at least one TE-mode resonator and/or at least one TM-mode resonator.

20. The microwave filter according to claim 19, wherein at least one of the coaxial resonators having a coupling means in its lower end wall and/or its upper end wall is coupled with a TE-mode resonator or a TM-mode resonator by means of a coupling means located in the lower end wall or in the upper end wall of the coaxial resonator.

21. The microwave filter according to claim 20, wherein the plurality of coupled resonators includes at least one pair of adjacent coupled resonators, one of the resonators forming such a pair being a coaxial resonator comprising in its lower end wall and/or in its upper end wall a coupling means and the other being a TE-mode resonator or a TM-mode resonator, wherein the coaxial resonator is disposed with its lower end wall its upper end wall adjacent the sidewall of the TE-mode resonator or TM-mode resonator, respectively, and wherein the two resonators comprise coupling means in the adjacent walls which coupling means are aligned with respect to each other and cooperate to provide the coupling between the two resonators.

22. The microwave filter according to claim 21, wherein in at least one of these pairs of coupled resonators formed by a coaxial resonator disposed with one of its end walls (adjacent the sidewall of a TE-mode resonator or a TM-mode resonator, the coaxial resonator is disposed with its lower end wall adjacent the sidewall of the TE-mode resonator or TM-mode resonator, respectively.

23. The microwave filter according to claim 19, wherein the TE-mode resonators and/or TM-mode resonators include at least one dielectric resonator (22c; 22f) and/or at least one cavity resonator.

24. The microwave filter according to claim 1, wherein the resonators are coupled in a two- or a three-dimensional array.

25. The microwave filter according to claim 1, wherein the resonators are coupled such that there is cross coupling between at least two of the resonators.

26. The microwave filter according to claim 25, wherein the resonators are coupled such that there is cross coupling between at least one of the coaxial resonators having a coupling means in its lower end wall and/or its upper end wall and an adjacent resonator, wherein the cross coupling is provided using a coupling means in the lower end wall or the upper end wall of the coaxial resonator.

27. The microwave filter according to claim 26, wherein at least one of the coupling means in the lower end wall or the upper end wall of one of the coaxial resonators providing cross coupling is adapted to provide negative cross coupling.

28. The microwave filter according to claim 26, wherein at least one of the coupling means in the lower end wall or the upper end wall of one of the coaxial resonators providing cross coupling is adapted to provide magnetic cross coupling with a negative cross coupling sign.

29. The microwave filter according to claim 1, wherein the plurality of coupled resonators only includes coaxial resonators.

30. The microwave filter according to claim 1, wherein at least one of the coaxial resonators having a coupling means in its lower end wall and/or its upper end wall has a cylindrical housing.

31. The microwave filter according to claim 1, wherein at least one of the coaxial resonators having a coupling means in its lower end wall and/or its upper end wall has a cylindrical inner conductor.

32. The microwave filter according to claim 1, wherein the plurality of coupled resonators includes at least one coaxial resonator comprising a coupling means in its lower end wall for coupling the respective coaxial resonator with an adjacent resonator.

33. The microwave filter according to claim 1, wherein the plurality of coupled resonators includes no coaxial resonator comprising a coupling means in its upper end wall.
